(19) United States
(12) Patent Application Publication
(10) Pub. No.: US 2017/0038868 A1
(43) Pub. Date: Feb. 9, 2017

(54) Touch Detection Method and Capacitive Sensing Device

(71) Applicant: Sitronix Technology Corp., Hsinchu County (TW)

(72) Inventors: Hung-Yen Tai, Hsinchu County (TW); Chun-Kuan Wu, Hsinchu County (TW); Ching-Jen Tung, Hsinchu County (TW)

(21) Appl. No.: 15/091,591

(22) Filed: Apr. 6, 2016

Related U.S. Application Data
(60) Provisional application No. 62/201,594, filed on Aug. 6, 2015.

(51) Int. Cl. G06F 3/044; G06F 3/041

(52) U.S. Cl. CPC G06F 3/044; G06F 3/0416

(57) ABSTRACT

A touch detection method for a capacitive sensing device is disclosed. The capacitive sensing device is utilized for detecting capacitance variance of a panel, and a variable capacitor includes a first end electrically coupled to the panel. The touch detection method includes simultaneously providing a first clock signal to a second end of the variable capacitor and providing a second clock signal to the panel; determining a touched region of the panel according to a voltage variance of the first end of the variable capacitor; and generating an output signal utilized for indicating the touched region. Notably, the first clock signal and the second clock signal have opposite phases against each other.

### CROSS REFERENCE TO RELATED APPLICATIONS

This application claims the benefit of U.S. Provisional Application No. U.S. 62/201,594 filed on Aug. 6, 2015, the contents of which are incorporated herein.

### BACKGROUND OF THE INVENTION

1. Field of the Invention

The present invention is related to a touch detection method and capacitive sensing device, and more particularly, to a touch detection method and capacitive sensing device simultaneously performing a mutual-sensing mode and a self-sensing mode.

2. Description of the Prior Art

With advances in touch control technology, more and more electronic devices are equipped with touch panels as main input interfaces to replace conventional keyboards and mice. The touch panel is a component attached to a display of the electronic device, and a user can command the electronic device by tabbing the touch panel via a finger or a touch pen. As a result, since the space conventionally allocated for the keyboard is no longer required, the display of the electronic device can be enlarged to improve user experiences.

According to sensing methods, the touch panels can be classified into resistive, capacitive, optical and acoustic types. The capacitive touch panels feature great sensitivity, and therefore are widely employed in various kinds of electronic devices. Specifically, a touched region of the capacitive touch panel is determined based on a capacitance change of the capacitive touch panel. However, in addition to capacitors designed by the manufacturer, there are parasitic capacitors in the capacitive touch panel. The parasitic capacitors lead to a bias in touch detection signals, which results in difficulties during the following recognition process. Therefore, the bias of the touch detection signals has to be removed.

### SUMMARY OF THE INVENTION

It is therefore an objective of the present invention to provide a touch detection method and capacitive sensing device capable of removing a bias component caused by parasitic capacitors so as to simplify a touch detection signal.

The present invention discloses a touch detection method for a capacitive sensing device, the capacitive sensing device utilized for detecting capacitance variance of a panel, a variable capacitor comprising a first end electrically coupled to the panel, the touch detection method comprising simultaneously providing a first clock signal to a second end of the variable capacitor and providing a second clock signal to the panel; determining a touched region of the panel according to a voltage variance of the first end of the variable capacitor; and generating an output signal utilized for indicating the touched region; wherein the first clock signal and the second clock signal have opposite phases against each other.

The present invention further discloses a capacitive sensing device for detecting capacitance variance of a panel, the capacitive sensing device comprising an input end, electrically coupled to the panel; an analog front-end circuit, electrically coupled to the input end, for determining a touched region of the panel according to a voltage variance of the input end and generating an output signal utilized for indicating the touched region; and a variable capacitor, comprising a first end, electrically coupled to the input end; and a second end, electrically coupled to analog front-end circuit, for receiving a first clock signal; wherein the first clock signal is provided to the second end when a second clock signal is provided to the panel; wherein the first clock signal and the second clock signal have opposite phases against each other.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a capacitive sensing device.

FIG. 2 is a schematic diagram of an ideal output signal of the capacitive sensing device of FIG. 1.

FIG. 3 is a schematic diagram of a practical output signal of the capacitive sensing device of FIG. 1.

FIG. 4 is a schematic diagram of an alternative embodiment of the capacitive sensing device of FIG. 1.

FIG. 5 is a schematic diagram of a capacitive sensing device according to an embodiment of the present invention.

FIG. 6 is a schematic diagram of a touch detection process according to an embodiment of the present invention.

FIG. 7 is a period allocation diagram of the touch detection process of FIG. 6.

### DETAILED DESCRIPTION

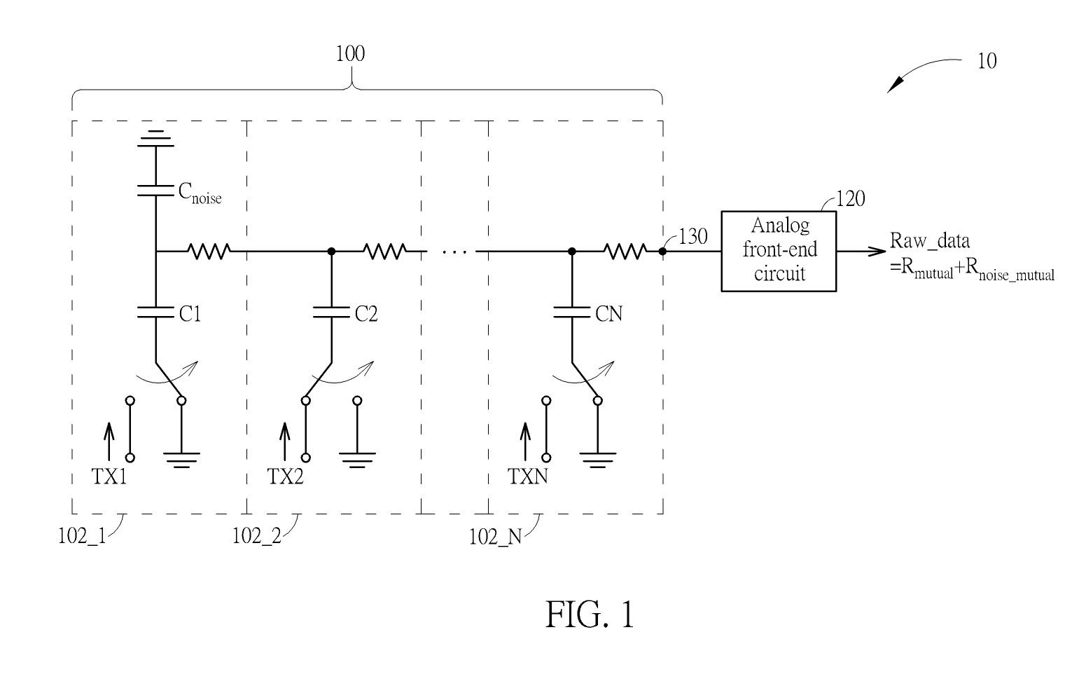

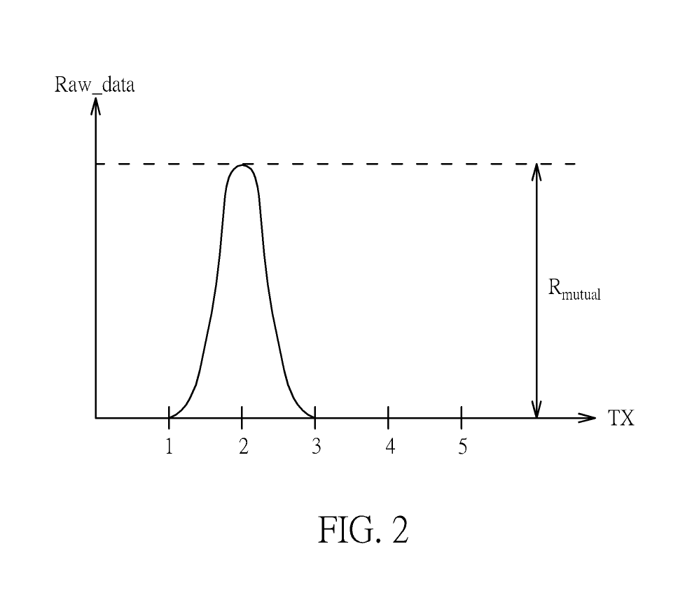

Please refer to FIG. 1, which is a schematic diagram of a capacitive sensing device 10. The capacitive sensing device 10 includes a panel 100 and an analog front-end circuit 120. The panel 100 includes multiple regions 102_1-102_N, each equivalent to a combination of an equivalent capacitor and an equivalent resistor, as shown in FIG. 1. First ends of the equivalent capacitors C1-CN are utilized for grounding or receiving driving signals TX1-TXN. During a mutual-sensing mode, the driving signals TX1-TXN are clock signals and sequentially fed into the panel 100. For example, when the driving signal TX1 is fed, the regions 102_2-102_N are grounded; when the driving signal TX2 is fed, the regions 102_1, 102_3-102_N are grounded; and so on. The analog front-end circuit 120 is utilized for detecting a voltage variance of an output end 130 when the driving signals TX1-TXN are fed and generating an output signal Raw_data utilized for indicating a touched region of the panel 100. For example, if a finger touches the region 102_2, a voltage of the output end 130 when the driving signal TX2 is fed into the panel 100 is significant different from the voltage of the output end 130 when the other driving signals TX1, TX3-TXN are fed. Such a difference is also reflected in the output signal Raw_data, as shown in FIG. 2. As such, the event that the finger touches the region 102_2 is detected.

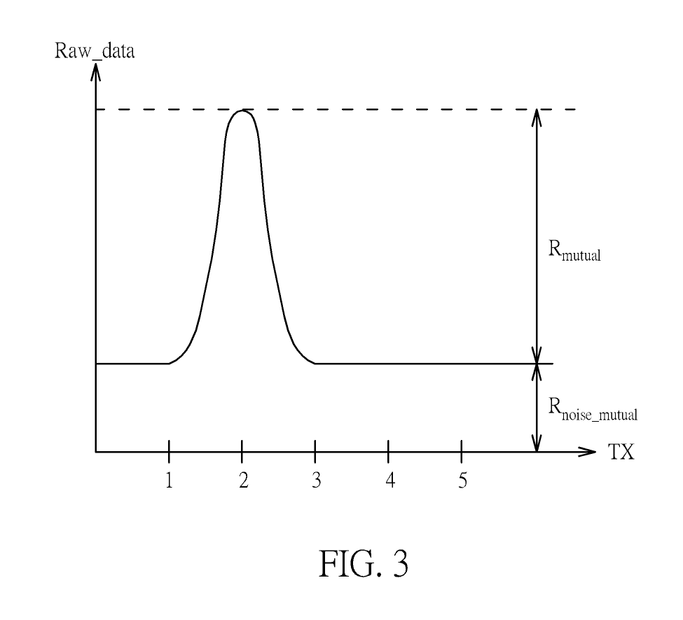

However, deficiencies of the panel 100 results in a parasitic capacitor Cₙₒᵢₛₑ, as shown in FIG. 1. The parasitic capacitor Cₙₒᵢₛₑ leads to a bias in the voltage of the output end 130, and such a bias is also reflected in the output signal Raw_data, i.e. Raw_data=Rₘᵤₜᵤₐₗ+Rₙₒᵢₛₑ_{_}ₘᵤₜᵤₐₗ, where Rₘᵤₜᵤₐₗ denotes a mutual-sensing signal component, and Rₙₒᵢₛₑ_{_}ₘᵤₜᵤₐₗ denotes a mutual-sensing bias component, as illustrated in FIG. 3.

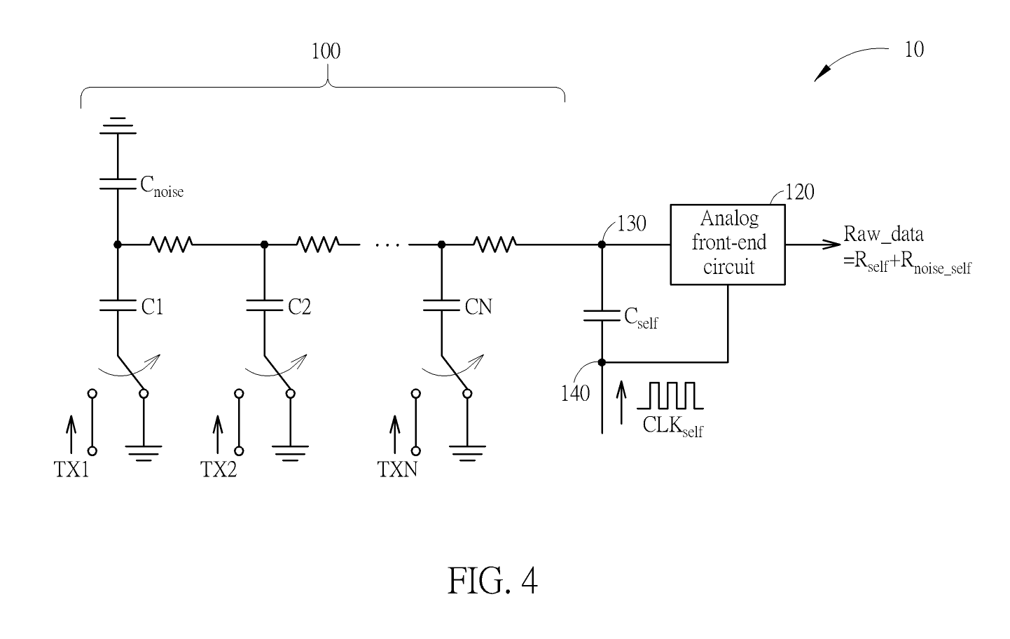

Other than the mutual-sensing mode, the capacitive sensing device 10 can be equipped with a self-sensing capacitor C_{self} via a switch circuit, as shown in FIG. 4. Notably, during the self-sensing mode, a node 140 additionally receives a self-sensing clock signal CLK_{self}, which is utilized for driving the self-sensing capacitor C_{self}. Similar to the deficiency of the mutual-sensing mode, the parasitic capacitor Cₙₒᵢₛₑ also leads to a bias in the output signal Raw_data, i.e. Raw_data=R_{self}+Rₙₒᵢₛₑ_{_}_{self}, where R_{self} denotes a self-sensing signal component, and Rₙₒᵢₛₑ_{_}_{self} denotes a self-sensing bias component.

Since both the mutual-sensing bias component Rₙₒᵢₛₑ_{_}ₘᵤₜᵤₐₗ and the self-sensing bias component Rₙₒᵢₛₑ_{_}_{self} are difficult to be identified in the following recognition process, the present invention further provides an embodiment below, which can remove the bias components Rₙₒᵢₛₑ_{_}ₘᵤₜᵤₐₗ, Rₙₒᵢₛₑ_{_}_{self} from the output signal Raw_data.

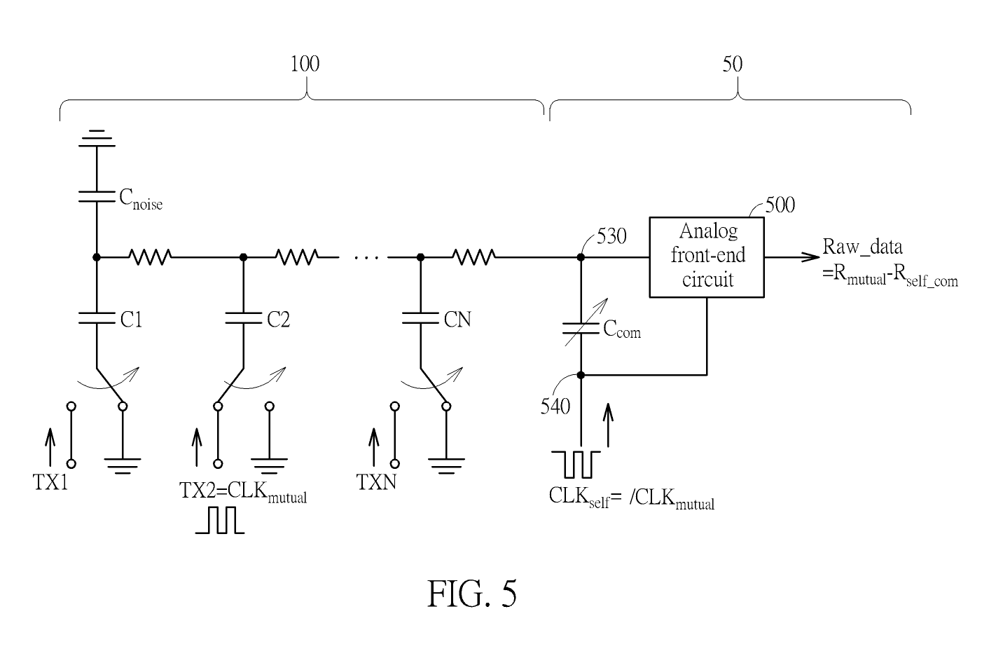

Please refer to FIG. 5, which is a schematic diagram of a capacitive sensing device 50 according to an embodiment of the present invention. The capacitive sensing device 50 is utilized for detecting capacitance variance of the panel 100, and includes an analog front-end circuit 500 and a variable capacitor C_{com}. The capacitive sensing device 50 receives a self-sensing clock signal CLK_{self} at a node 540. When the capacitive sensing device 50 receives the self-sensing clock signal CLK_{self}, the panel 100 sequentially receives driving signals TX1-TXN. Notably, the driving signals TX1-TXN are in the form of a mutual-sensing clock signal CLKₘᵤₜᵤₐₗ, and the mutual-sensing clock signal CLKₘᵤₜᵤₐₗ and the self-sensing clock signal CLK_{self} have opposite phases against each other, i.e. CLK_{self}=/CLKₘᵤₜᵤₐₗ. The analog front-end circuit 500 is utilized for determining a touched region of the panel 100 according to a voltage variance of an input end 530 and generating an output signal Raw_data utilized for indicating the touched region.

In other words, the capacitive sensing device 50 is a combination of the mutual-sensing embodiment of FIG. 1 and the self-sensing embodiment of FIG. 4. According to the superposition theory, the analog front-end circuit 500 generates the output signal Raw_data=Rₘᵤₜᵤₐₗ+Rₙₒᵢₛₑ_{_}ₘᵤₜᵤₐₗ−(R_{self}_{_}_{com}+Rₙₒᵢₛₑ_{_}_{com}), where Rₘᵤₜᵤₐₗ denotes a mutual-sensing signal component caused by the mutual-sensing clock signal CLKₘᵤₜᵤₐₗ, Rₙₒᵢₛₑ_{_}ₘᵤₜᵤₐₗ denotes a mutual-sensing bias component caused by the parasitic capacitor Cₙₒᵢₛₑ in response to the mutual-sensing clock signal CLKₘᵤₜᵤₐₗ, R_{self}_{_}_{com} denotes a self-sensing signal component caused by the variable capacitor C_{com} in response to the self-sensing clock signal CLK_{self}, and Rₙₒᵢₛₑ_{_}_{com} denotes a self-sensing bias component caused by the parasitic capacitor Cₙₒᵢₛₑ in response to the self-sensing clock signal CLK_{self}. Via tuning the capacitance of the variable capacitor C_{com}, Rₙₒᵢₛₑ_{_}ₘᵤₜᵤₐₗ=Rₙₒᵢₛₑ_{_}_{com}. In such a situation, the output signal Raw_data=Rₘᵤₜᵤₐₗ−R_{self}_{_}_{com}, and does not include any component caused by the parasitic capacitor Cₙₒᵢₛₑ, which means that the bias component is successfully removed.

Notably, the mutual-sensing clock signal CLKₘᵤₜᵤₐₗ and the self-sensing clock signal CLK_{self} may be designed to have opposite phases against each other, such that R_{self}_{_}_{com} and Rₙₒᵢₛₑ_{_}_{com} caused by the self-sensing clock signal CLK_{self} are negative, and the mutual-sensing bias component Rₙₒᵢₛₑ_{_}ₘᵤₜᵤₐₗ can counteract the self-sensing bias component Rₙₒᵢₛₑ_{_}_{com}. In addition, the parasitic capacitor Cₙₒᵢₛₑ varies with the panel, and varies with a position on the panel. Therefore, the capacitance of the parasitic capacitor Cₙₒᵢₛₑ also has to be adjusted based on practical conditions, so as to remove parasitic capacitors of different panels. In practice, the capacitance of the variable capacitor C_{com} can be determined based on experiments or computer simulations.

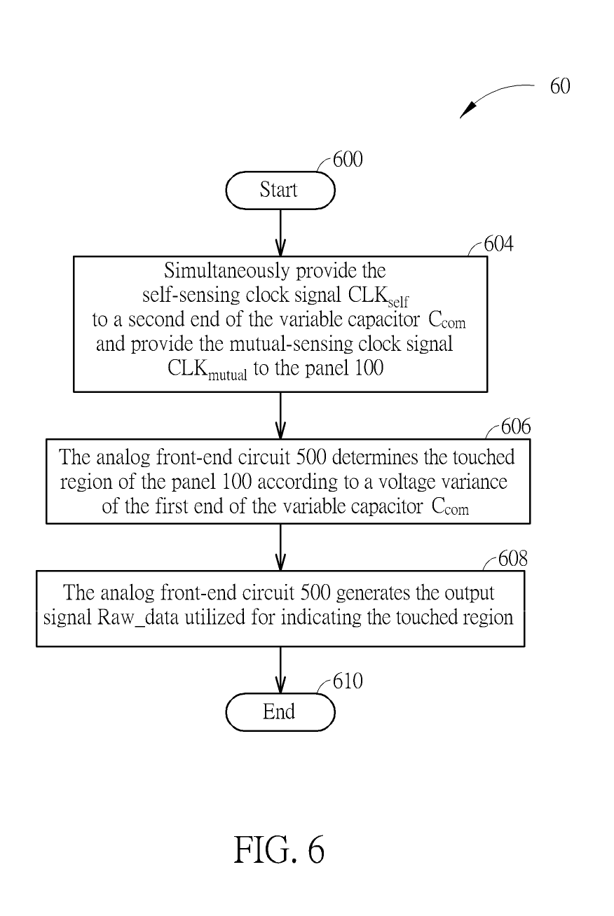

Operations of the capacitive sensing device 50 can be summarized into a touch detection process 60, as illustrated in FIG. 6. The touch detection process 60 includes the following steps:

### Step 600: Start.

Step 604: Simultaneously provide the self-sensing clock signal CLK_{self} to a second end of the variable capacitor C_{com} and provide the mutual-sensing clock signal CLKₘᵤₜᵤₐₗ to the panel 100.
Step 606: The analog front-end circuit 500 determines the touched region of the panel 100 according to a voltage variance of the first end of the variable capacitor C_{com}.
Step 608: The analog front-end circuit 500 generates the output signal Raw_data utilized for indicating the touched region.

### Step 610: End.

Via the touch detection process 60, the output signal Raw_data=Rₘᵤₜᵤₐₗ−R_{self}_{_}_{com} no longer includes any bias component caused by the parasitic capacitor Cₙₒᵢₛₑ. In other words, the output signal uses Raw_data=0 to represent a non-touch region of the panel 100. Such a representation can be easily interpreted to find out whether there is a touch region, so as to simplify the recognition process.

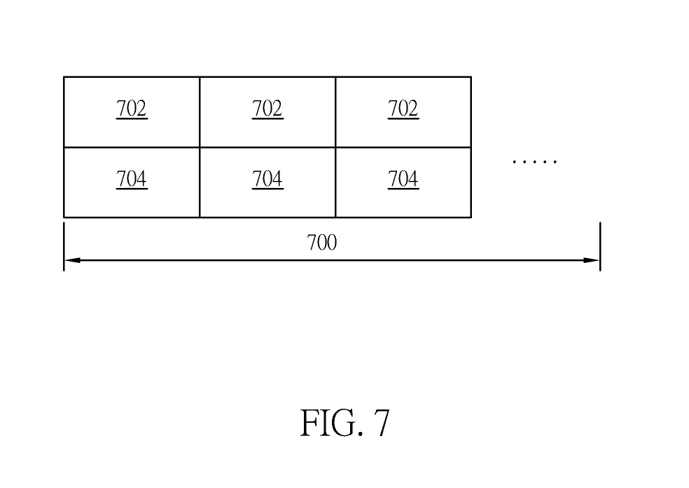

Notably, the touch detection process 60 implements both the self-sensing mode and the mutual-sensing mode, as illustrated in FIG. 7. In FIG. 7, 700 denotes a period required to fully scan the panel 100 once for touch detection, 702 denotes a period required to perform self-sensing once, and 704 denotes a period required to perform mutual-sensing once. According to the time allocation, the self-sensing mode and the mutual-sensing mode can be synchronized completely.

To sum up, the present invention utilizes signal correlation between the self-sensing mode and the mutual-sensing mode to simultaneously implement the self-sensing mode and the mutual-sensing mode. As a result, by feeding the opposite phase clock signal, the bias signal components of the self-sensing mode and the mutual-sensing mode counteract each other, so as to simplify the touch sensing signal.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch detection method for a capacitive sensing device, the capacitive sensing device utilized for detecting capacitance variance of a panel, a variable capacitor comprising a first end electrically coupled to the panel, the touch detection method comprising:
simultaneously providing a first clock signal to a second end of the variable capacitor and providing a second clock signal to the panel;
determining a touched region of the panel according to a voltage variance of the first end of the variable capacitor; and
generating an output signal utilized for indicating the touched region;
wherein the first clock signal and the second clock signal have opposite phases against each other.

2. The touch detection method of claim 1, wherein the panel comprises a plurality of regions.

3. The touch detection method of claim 2, wherein the step of providing the second clock signal to the panel comprises:
sequentially providing the second clock signal to one of the plurality of regions.

4. The touch detection method of claim 1, further comprising:
changing capacitance of the variable capacitor, such that a mutual-sensing bias component of the output signal is equal to a self-sensing bias component caused by a parasitic capacitor in response to the first clock signal.

5. A capacitive sensing device for detecting capacitance variance of a panel, the capacitive sensing device comprising:
an input end, electrically coupled to the panel;
an analog front-end circuit, electrically coupled to the input end, for determining a touched region of the panel according to a voltage variance of the input end and generating an output signal utilized for indicating the touched region; and
a variable capacitor, comprising:
a first end, electrically coupled to the input end; and
a second end, electrically coupled to analog front-end circuit, for receiving a first clock signal;
wherein the first clock signal is provided to the second end when a second clock signal is provided to the panel;
wherein the first clock signal and the second clock signal have opposite phases against each other.

6. The capacitive sensing device of claim 5, wherein the panel comprises a plurality of regions.

7. The capacitive sensing device of claim 6, wherein the second clock signal is sequentially provided to one of the plurality of regions.
